(19) United States
(12) Patent Application Publication
(10) Pub. No.: US 2009/0271012 A1
(43) Pub. Date: Oct. 29, 2009

(54) Method or System for Displaying an Internet Page on a Visualization Device of an Industrial Automation Device

(76) Inventors: Markus Kopka, Ditzingen (DE); Thomas Malik, Hildrizhausen (DE); Edgar Wolf, Herrenberg/Haslach (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/991,997

(22) PCT Filed: Sep. 7, 2006
(86) PCT No.: PCT/EP2006/066124

§ 371 Date: Mar. 13, 2008

(30) Foreign Application Priority Data
Sep. 27, 2005 (DE) 102005046166.2

(51) Int. Cl. G05B 15/02; G06F 15/16

(52) U.S. Cl. 700/83; 709/246

(57) ABSTRACT

There is described a method for displaying an Internet page an/or an intranet page on a visualization device of an industrial automation device, wherein the method relates to data of the Internet page and/or intranet page which are stored in a first data format on a server. In this case, the industrial automation device can be unburdened of tasks for displaying the page. The data of the Internet page and/or intranet page can be transmitted to a data processing device via the Internet and/or an intranet and can be received by the data processing device, after which the data processing device converts the data of the Internet page and or intranet page, which are in the first data format, into a second data format, after which these converted data are transmitted to the industrial automation device and/or to the visualization device of the industrial automation device. Following this, the page can be fully or partially displayed on the visualization device of the industrial automation device.

### CROSS REFERENCE TO RELATED APPLICATIONS

This application is the US National Stage of International Application No. PCT/EP2006/066124, filed Sep. 7, 2006 and claims the benefit thereof. The International Application claims the benefits of German application No. 10 2005 046 166.2 DE filed Sep. 27, 2005, both of the applications are incorporated by reference herein in their entirety.

### FIELD OF INVENTION

The present invention relates to a method or a system for displaying an internet page and/or an intranet page on a visualization device, which is allocated to an industrial automation device.

### BACKGROUND OF INVENTION

When displaying internet or intranet pages, which are subsequently also referred to in short as pages, one is faced again and again with the problem that although these pages can be easily displayed on a standard PC because of its high computing power, the computing power of industrial automation devices sometimes hits capacity limits, when said industrial automation devices have to provide the functions of a browser. The reason for this is in particular that the industrial automation devices are primarily used to control and regulate and the visualization of data and information is usually a secondary task of such industrial automation devices. The limited resources in the case of the industrial automation device affect not only the computing power of a processor used in this device, but also the size of the main memory used for example. The automation device is for example a stored program controller, a computer numerical control (CNC) or similar. The visualization device is for example an LCD display, a TFT display, a CRT monitor, etc.

However, in order to be able to display pages on the visualization device for the industrial automation device, it has previously been necessary to make more computing power and memory available for this functionality, i.e. for example for an internet browser, which is, however, only necessary during the time the visualizations task is being carried out and which is moreover a waste of hardware resources.

Further examples of industrial automation devices are, in addition to production machines, machine tools, handling robots, lifting equipment, which represent complex systems, also subcomponents of said systems such as, for example, controllers, regulators, converters and similar. Displays are used to display data and information concerning the industrial automation device. The display is a simple embodiment of a Human Machine Interface (HMI), which advantageously also has input possibilities in the form of a keyboard or a cursor or a touch screen, where a temporal object serves as a cursor. The HMI is used for example to display actual values of the industrial automation device. In addition, the HMI can also be used for operator control actions on the industrial automation device.

A person using the HMI is advantageously able to access a page on the internet or intranet. The use of high level languages, such as HTML or Java, make it necessary to provide corresponding computing powers and resources in the industrial automation device to display said page. The resources problem also arises when displaying a vector graphic, which can also be provided via such pages.

The problem of displaying internet pages on a visualization device does not only affect industrial automation devices, to which a visualization device is allocated, but also visualization devices of objects such as:

mobile radio units,

organizers (PDA),

household appliances (e.g. a refrigerator, an electric cooker, a deep freeze cabinet, etc.),

means of transportation (e.g. automobiles, trucks, railway vehicles, etc.)

etc.

If the visualization device is used with such objects and if, for example, a page from the internet is to be displayed on the visualization device, then, up to now, either the visualization device itself or also the allocated object must have a web browser, which interprets the language commands in order to display the page. This also places high demands on the resources of the device or the visualization device.

### SUMMARY OF INVENTION

An object of the invention is to specify a method or a system that enables a page from the internet or intranet to be displayed and/or used in particular for an industrial automation device, enabling the demands placed on the resources of the industrial automation device to be reduced.

The object is achieved by a method and a system with the features as claimed in independent claims. Dependent claims show further features.

A method for displaying an internet page and/or an intranet page—subsequently also referred to in short as a page—on a visualization device, in particular an industrial automation device, relates to data for describing the internet page and/or the intranet page, which data is stored in a first data format on a server. The first data format is in particular a format that uses or concerns a high level language. Examples of high level languages are HTML, XML, Java, etc. The server is connected to a network, such as, e.g. the internet, an intranet, an Ethernet or similar. The data relates for example to only one or also several internet pages and/or intranet pages. The data of the internet page and/or the intranet page are transmitted to a data processing device via the internet and/or an intranet, after which the data processing device converts the data of the internet page and/or the intranet page, which is in the first data format, into a second data format. This second data format is in particular a format that requires less computing power in order to display the page. Such a second data format is, for example, one which is pixel-oriented. Examples of this are formats such as Bitmap, JPG, TIFF or similar. The data converted into the second data format is transmitted to the industrial automation device and/or to the visualization device in particular of the industrial automation device. The page can then be displayed fully or partially on the visualization device, in particular on the industrial automation device. The automation device is in particular a device for regulating and/or controlling, such as, for example, an SPC. The visualization device used is for example a screen based on a cathode ray tube, a plasma screen, an LCD screen, a video projector or similar.

In addition to the visualization device of an industrial control system, the invention also relates to the visualization device of other objects, such as for example mobile radio units, organizers (PDA), household appliances, means of transportation.

The method according to the invention of converting data in a data processing device simplifies the display of pages that are written using language commands on such visualization devices of devices (see above). In the following, the invention is related in particular to the visualization device of an industrial automation device. However, in addition to the industrial automation devices, the embodiments described below also relate to other objects (see above), which have a visualization device. In particular in the case of these objects, a visualization device is understood not only to mean a display unit used (e.g. the cathode ray tube) but also an associated computing unit. An associated computing unit of this kind is in particular an embedded system. Devices such as mobile phones, organizers or also automobiles can have computing units, which are allocated to a visualization device. In the case of motorcars, this is, for example, an on-board computer that can calculate the fuel consumption and then displays this on an associated display as a visualization device. Therefore, if, in the embodiments of the invention described below, the described industrial automation device shows special features, then this also relates to a method or a system where a device (see above) has this corresponding feature.

According to the invention, the page data is transmitted via the internet and/or an intranet to the data processing device. This transmitted data can be vector-oriented graphic data as well as data in a high level language. As, after the data has been transmitted to the data processing device, the page data is converted e.g. into a pixel-oriented data format, an internet browser is no longer necessary in the automation device or in the visualization device. This saves computing power and memory. Advantageously the data format can be converted centrally by a data processing device for two or several industrial automation devices or visualization devices. The data in the pixel-oriented data format is transmitted to the industrial automation device and/or to the visualization device of the industrial automation device. After this, the page is displayed fully or partially on the visualization device of the industrial automation device. The transmission between the data processing device and the industrial automation device or the visualization device is carried out, for example, using the internet or the intranet or also using an Ethernet or a field bus. Examples of field buses are Profibus® and CAN-Bus®. If the data is transmitted between the industrial automation device and the visualization device, then it is also possible for this purpose to use an intranet- or an Ethernet-based bus or a field bus for example or also a proprietary system to transmit the data.

Using the inventive method it is possible to save computing power on the industrial automation device, as one can display pixel-oriented data on the visualization device and conserve resources. Only one type of bitmap browser is in particular needed from now on in order to display the page. The process of converting the data from the first data format into the second data format can also be called rendering. This relates in particular to the conversion of high level language-oriented data of the internet page or intranet page into a pixel-oriented data format. In this context, the term “rendering” is understood to mean a translation or a transfer of data from one format into another format. Here the source format is for example an HTML or XML-based internet page, which is converted into a complete image by executing a rendering process. This process of converting the internet page has previously been carried out on the device which received the page data and on which the corresponding data is to be displayed. This process is carried out for example by a browser such as Netscape®, Firefox® or the internet Explorer®. According to the invention, the processing of the page data stored on a server, which is requested by a client, is spatially separated from the location where the page is displayed. In this way, the data processing device can also be called a render server.

In order to reduce the size and scope of the data converted into a pixel-oriented data format, it is advantageous for said data to be compressed on the data processing device and the compressed data transmitted, for example, via the internet or the intranet or similar to the industrial automation device, where these are decompressed again and used for the display on the visualization device. The inventive method enables the resource-intensive process of rendering to be carried out on a server or computer of any high-capacity as a data processing device, while the resource requirement of the industrial automation device of the client is thus reduced. Thereby, these resources relate in particular to the processor performance of the processor used in the industrial automation device and the size of the memory used there.

In a further advantageous embodiment of the method, the data processing device has, as already described, a data link to the industrial automation device and/or the visualization device by means of a network such as, for example, the internet or by means of a field bus. Furthermore, it is advantageous if the industrial automation device transmits parameter data of the visualization device to the data processing device. As the visualization device can be understood as a part of an industrial automation device or as an industrial automation device itself, it is also possible that the visualization device itself transmits the parameter data to the data processing device. The parameter data is used in the conversion of the page into the second data format, thus, for example, into the pixel-oriented data format. Examples of parameter data is in particular the number of pixels of the visualization device, the size of a screen, the maximum or also the optimal resolution of the visualization device or further parameter data.

Further parameter data also relates for instance to information relating to additional input devices, which relate to the visualization device. Such input devices are, for example, keys, a touch-screen function, a cursor or similar. Thus operating functions of the page to be displayed can be transmitted, for example, to such additional functionalities of the visualization device.

In a further advantageous embodiment of the inventive method, the industrial automation device requests a page from the data processing device or a page is provided for displaying on the visualization device, whereby the data processing device requests the page data from the server or servers on which the page is stored. Thus it is possible for example for a person on an HMI to request the display of a specific page in the internet, whereby this request is sent first to the data processing device, which subsequently retrieves the corresponding page, converts it and sends it to the visualization device or to the industrial automation device.

Advantageously, a method step is provided which enables an interactive element of the page and/or an animated element of the page and/or a cookie allocated to the page to be detected by the data processing device, whereupon additional data relating to this element is generated, whereby this additional data enables in particular an allocation of this element and/or of the cookie to a position of pixels for displaying on the visualization device.

In a further advantageous embodiment, the additional data is used to form a display superimposed over the page on the visualization device.

In a further embodiment, the position of a cursor is recognized on the visualization device and positional information is transmitted to the data processing device. In this way actions, instructions and functions of the page can be copied, so that no and/or negligible limitations in functionality are associated with the conversion, for example, into a pixel-oriented data format.

According to the invention, the method can be furthermore developed to the effect that the additional data (e.g. via buttons and/or input fields on the page) is linked to the industrial automation device with an operator control action, whereupon result data is produced, which is transmitted to the data processing device and/or to the server. An example of this is the input of data into an input field of the page. By means of the industrial automation device for example, alphanumeric character information is input and linked to additional information via the input field of the page, result data being created from this. This result data is transmitted to the data processing device, whereby the data processing device recognizes the link and transmits the alphanumeric character information to the server of the page.

In the case of the method presented, it is advantageous if information relating to the page shown is also transmitted with the pixel-oriented data format. If at the visualization device selection processes or inputs concerning the visualization device or suchlike are made, which are to be sent back to the server that is providing the page, then information relating to the displayed page is also sent to the data processing device along with this input data. By means of this information (e.g. the internet address) of the page displayed on the visualization device, this page can be identified by the data processing device and can be requested again on the page server. This allows the information to be forwarded for an existing page functionality (e.g. a button or an input field).

In addition to the method, the invention also relates to a system for displaying an internet page and/or an intranet page on a visualization device of an industrial automation device. In a system of this kind, provision is made for a data processing device for converting the page data into another data format, wherein the converted data is intended for a visual display on the visualization device. A system of this kind is used in particular to carry out one of the methods described above. A network and/or a bus system for data transmission is located between the data processing device and the industrial automation device. The network or the bus system can be realized by means of cables or by means of a radio transmission.

### BRIEF DESCRIPTION OF THE DRAWINGS

Examples of prior art or further advantages and details of the invention result from the following description of an embodiment, in which;

FIG. 1 shows the prior art and

FIG. 2 shows an exemplary embodiment of the invention.

### DETAILED DESCRIPTION OF INVENTION

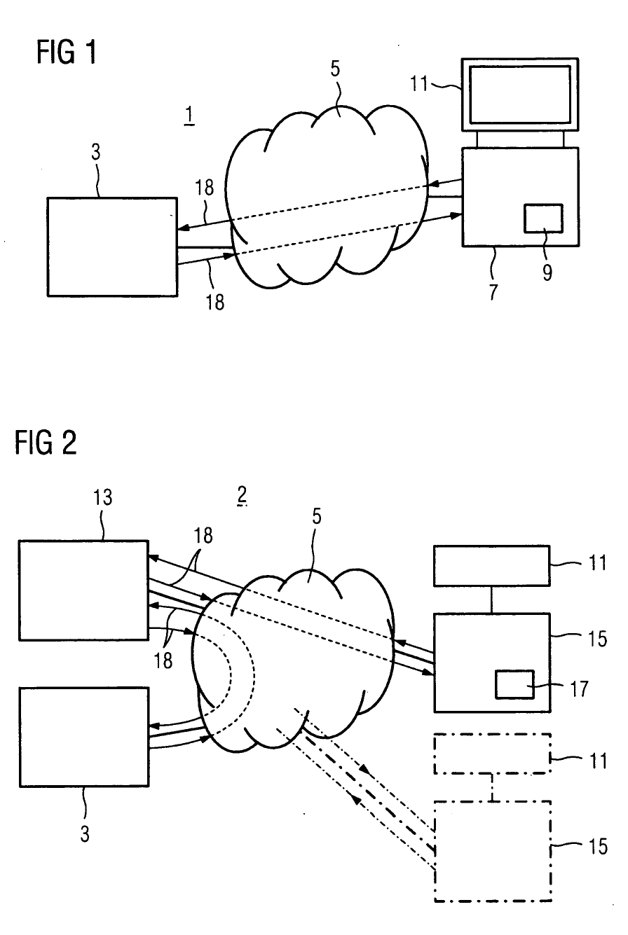

The representation according to FIG. 1 shows the prior art. A system 1 according to the prior art serves to display an internet page, wherein an internet browser 9 is used. The internet browser 9 runs on a client system, wherein the client system is for example a Personal Computer (PC) 7. One or several internet pages are stored on a web server 3. The data which describe the internet page can be transmitted to the client 7 via the internet 5. The corresponding method is executed for example in such a way that the internet browser 9 requests the page directly from the web server 3. The web server 3 delivers the page for example in an HTML format. The internet page is displayed on the client 7 with the help of the internet browser 9, by interpreting the page data stored in HTML format. After the data in HTML format has been interpreted, the internet browser 9 displays an image on a visualization device 11. The visualization device 11 is, for example, an LCD screen. In FIG. 1 the data transfer between the web server 3 and the personal computer is represented by arrows 18.

The representation according to FIG. 2 shows a schematic example of a method according to the invention or of a system 2 according to the invention, wherein the system 2 represents a device. The representation shows a web server 3, a render server 13 and an industrial automation device 15. The web server 3 is a server, on which at least one internet page or one intranet page is stored. The render server 13 is a data processing device, which is designed to convert data, wherein the data relate to an internet page or an intranet page and are converted from a first data format into a second data format. The industrial automation device 15 functions as a client and is, for example, a device for controlling and/or regulating. A visualization device 11 is allocated to the industrial automation device. The industrial automation device 15 has a bitmap browser 17. The bitmap browser 17 is a software for interpreting data, which are in a pixel-oriented format. In a first procedure step the client 15 directs, for example, a request to the render server 13 for a web page available in the internet 5 on the web server 3. The render server 13 is a data processing device for converting the page data that is in a high level language or a vector graphic, which page, is stored for example on a web server 3. Advantageously, the client 15 sends to the render server 13 parameter values of the client and in particular of the visualization device 11, which is allocated to the client 15. Such parameters relate, for example, to a current screen resolution or further characteristics that the render server 13 requires to process the request and to convert the page data. These parameters are transmitted for example even before a request for a web page available in the internet is sent or also are sent together with this request.

In a further step, the render server 13 for its part queries the page from the web server 3 that is to be displayed and that was queried by the client server 3. The query is made in particular via the internet 5 or an intranet. The communication between the client 15 and the render server 13 can also be made via an internet or intranet connection and is also shown as such in FIG. 2. In a subsequent step, after the page requested from web server 3 has been received, the render server 13 uses the resources available to it to render the page to be displayed. As the render server 13 is advantageously used to convert data for different clients 15, the render server 13 can be accordingly generously equipped with resources, as two or more clients 15 share these resources of the render server 13. An additional industrial automation device 15 is represented by a dot-dashed line in FIG. 2 by way of example.

Advantageously, the render server 13 as a data processing device furthermore extracts all or also only some interactive elements (e.g. input fields, buttons etc.) of the page (internet page or intranet page) and converts these into a data format that is intelligible to the bitmap browser 17 of the client 15, wherein this data format contains in particular the type of existing elements as well as their position within the pixel-oriented data format or of the pixels represented. This converted data is additional page data. Cookies that are possibly to be stored on the page are likewise advantageously integrated as additional data into a data structure that is intelligible to the bitmap browser.

The rendered bitmap is transmitted to the client 15 and to the bitmap browser 17 running there. The data structure sent additionally to the bitmap is read in and interpreted by the bitmap browser. The data structure contains additional data.

Advantageously, the included interactive elements are replaced by the elements made available by the local graphics system, as the visualization device 11, and additionally displayed to the bitmap supplied by the render server 13. If, for example, a user clicks on a hyperlink or on a button, then this results again in a request by the client 15 to the render server 13 for a web page available on the internet. The hyperlink or also the button and its coordinates within the bitmap can be interpreted using the data structures supplied and allocated to the URL to be queried. Control elements such as textboxes, buttons etc. are represented on the client 15 by the respective graphic system available. The bitmap browser 17 stores cookies for example and accordingly sends them back to the web server 3, so that every query from the render server 13 can be carried out without the context being stored on the server side.

1.-8. (canceled)

9. A method for displaying an internet page or an intranet page on a visualization device, wherein data of the internet page or intranet page are stored in a first data format on a server, comprising:
receiving the data by a data processing device;
converting the data from the first data format in a second data format;
transmitting the converted data to an industrial automation device or to the visualization device; and
displaying the converted data of the page fully or partially on the visualization device.

10. The method as claimed in claim 9, wherein the converted data are transmitted via a field bus to the automation device, wherein the visualization device is assigned to the automation device.

11. The method as claimed in claim 9, wherein a parameter data of the visualization device is transmitted to the data processing device, wherein the conversion of the data of the page is based upon the parameter data.

12. The method as claimed in claim 10, wherein a parameter data of the visualization device is transmitted to the data processing device, wherein the conversion of the data of the page is based upon the parameter data.

13. The method as claimed in claim 11, wherein the conversion of the page is a conversion into the pixel-oriented data format.

14. The method as claimed in claim 12, wherein the conversion of the page is a conversion into the pixel-oriented data format.

15. The method as claimed in claim 9, wherein the industrial automation device or the visualization device requests the page from the data processing device.

16. The method as claimed in claim 11, wherein the industrial automation device or the visualization device requests the page from the data processing device.

17. The method as claimed in claim 12, wherein the industrial automation device or the visualization device requests the page from the data processing device.

18. The method as claimed in claim 15, wherein the data processing device queries the page data from the server.

19. The method as claimed in claim 9, wherein the data processing device queries the page data from a plurality of servers.

20. The method as claimed in claim 9, wherein the conversion of the page is a conversion into the pixel-oriented data format, wherein an interactive element of the or an animated element of the page or a cookie allocated to the page is detected by the data processing device, wherein additional data on this element are generated, wherein the additional data enables an allocation of the element or the cookie to a position of pixels for the display on the visualization device.

21. The method as claimed in claim 20, wherein the additional data are used to form a display superimposed over the page on the visualization device.

22. The method as claimed in one of claim 9, wherein a position of a cursor on the visualization device is recognized and positional information is transmitted to the data processing device.

23. The method as claimed in one of claim 21, wherein a position of a cursor on the visualization device is recognized and positional information is transmitted to the data processing device.

24. The method as claimed in claim 20, wherein the additional data are linked to an operator control action on the industrial automation device or on the visualization device.

25. The method as claimed in claim 24, wherein result data are produced based upon the additional data and transmitted to the data processing device or to the server.

26. A system for displaying an internet page or an intranet page on a visualization device of an industrial automation device, comprising:
a data processing device converts the page data into a pixel-oriented data format, wherein the converted data is provided for a visual display on the visualization device.

27. The system as claimed in claim 25, wherein a parameter data of the visualization device is transmitted to the data processing device, wherein the conversion of the data of the page is based upon the parameter data, wherein the conversion of the page is a conversion into the pixel-oriented data format, and wherein the page is displayed partially.

28. The system as claimed in claim 27, wherein the industrial automation device or the visualization device requests the page from the data processing device, wherein the converted data are transmitted via a field bus to the automation device, and wherein the visualization device is assigned to the automation device.
